(19) United States
(12) Patent Application Publication
(10) Pub. No.: US 2022/0396196 A1
(43) Pub. Date: Dec. 15, 2022

(54) SLOW MOVING VEHICLE WARNING LIGHT

(71) Applicant: TAMMY HULL, PRINCETON, IN (US)

(72) Inventor: TAMMY HULL, PRINCETON, IN (US)

(21) Appl. No.: 17/345,595

(22) Filed: Jun. 11, 2021

(51) Int. Cl. B60Q 1/00; B60Q 1/26; F21S 43/14

(52) U.S. Cl. CPC B60Q 1/0023; B60Q 1/2615; B60Q 1/2696; F21S 43/14; F21Y 2115/10

(57) ABSTRACT

A device for alerting approaching vehicles of a slow-moving vehicle is provided. The device includes a light bar having one or more illumination units positioned on a front face thereof, a sensing unit, and means for activating the one or more illumination units on the light bar. The light bar further includes a mounting mechanism on a rear face thereof for removably mounting the light bar on a vehicle. The sensing unit senses the location and speed of the vehicle and for compares the speed of the vehicle to a posted speed limit for a roadway upon which the vehicle is traveling. The activating means serve to activate the one or more illumination units when the sensing unit determines that the speed of the vehicle is less than a pre-determined value below the posted speed limit for the roadway.

### BACKGROUND OF THE INVENTION

### Field of the Invention

The present invention relates to a safety device for vehicles. More specifically, the present invention relates to a light bar for mounting on a vehicle to offer visible notification of a vehicle traveling below the posted speed limit.

### Description of the Related Art

Rear-end accidents are among the most common types of car accidents. According to one study, about 29 percent of all car accidents are rear-end collisions. Statistics provided by the Insurance Information Institute indicate that rear-end collisions are responsible for over seven percent of all traffic-related fatalities and nearly 20 percent of those fatalities involving two-vehicle collisions. Approximately 1.7 million rear-end collisions take place in the United States each year, resulting in about 1,700 deaths and 500,000 injuries.

Many of these accidents occur when the vehicle that is rear-ended is traveling at a speed that is significantly less than the posted speed limit. In such cases, if the driver of the second vehicle is not paying close attention, he/she will be unable to avoid a collision with the much slower moving vehicle in front, and has little, if any warning that the other vehicle is traveling at such a slow rate of speed until it is too late.

Accordingly, there is a need for a warning device that can be removably placed on the back of a potentially slow-moving vehicle to warn approaching vehicles of the potential hazard. Such a device, to be most effective, will be triggered to activate automatically upon the vehicle reaching a pre-determined threshold speed below the posted speed limit.

### SUMMARY OF THE INVENTION

It is therefore an object of the present invention to provide an LED light attachment for slow-moving vehicles, mounted to offer visible notification of a vehicle traveling below the posted speed limit.

It is also an object of the invention to provide an LED light attachment for slow-moving vehicles that pairs wirelessly with a GPS unit inside the vehicle, determining when to activate the light based on the vehicle's traveling speed and the posted speed limit. The device may flash in yellow or red colors to notify other motorists that the vehicle is traveling at slow speeds, thus reducing the chance of rear-end collisions, injuries, and even death while traveling. The device may function as an attachment for any make, model, and type of residential or commercial vehicle.

The present invention meets these objects by providing a device for alerting approaching vehicles of a slow-moving vehicle comprising a light bar having one or more illumination units, a sensing unit, and means for activating the one or more illumination units. The illumination units may be positioned on a front face of the light bar and a mounting mechanism is positioned on a rear face of the light bar for removably mounting the light bar on a vehicle. The sensing unit is used for sensing the location and speed of the vehicle and for comparing the speed of the vehicle to a posted speed limit for a roadway upon which the vehicle is traveling. The activating means serves to activate the one or more illumination units when the sensing unit determines that the speed of the vehicle is less than a pre-determined value below the posted speed limit for the roadway.

The mounting mechanism may include one or more magnets. The one or more illumination units may include one or more LED lights. The one or more LED lights may be configured to flash yellow when the vehicle is less than a first pre-determined value below the posted speed limit for the roadway. The one or more LED lights may further be configured to flash red when the vehicle is less than a second pre-determined value below the posted speed limit for the roadway.

The sensing unit may be a GPS unit. The light bar and GPS unit may be in wireless communication with each other. The GPS unit may be located in a passenger compartment of the vehicle.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a front perspective view of a slow moving vehicle warning light according to a preferred embodiment of the present invention.

FIG. 2 is a rear elevational view of the warning light of FIG. 1.

FIG. 3 is a perspective view of the warning light of FIG. 1 shown mounted on the rear of a tractor-trailer.

FIG. 4 is a perspective view of the warning light of FIG. 1 shown activated and mounted on the rear of a tractor-trailer and also on the rear of a passenger vehicle.

FIG. 5 is a schematic drawing showing the warning light paired with a GPS unit.

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

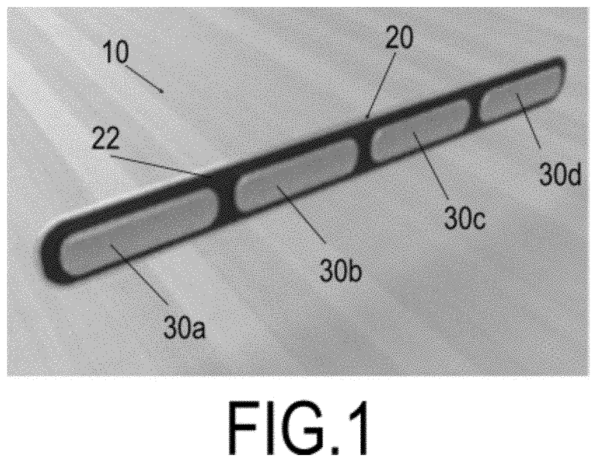

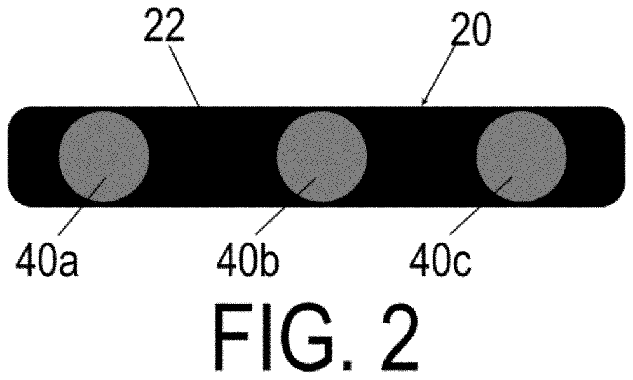

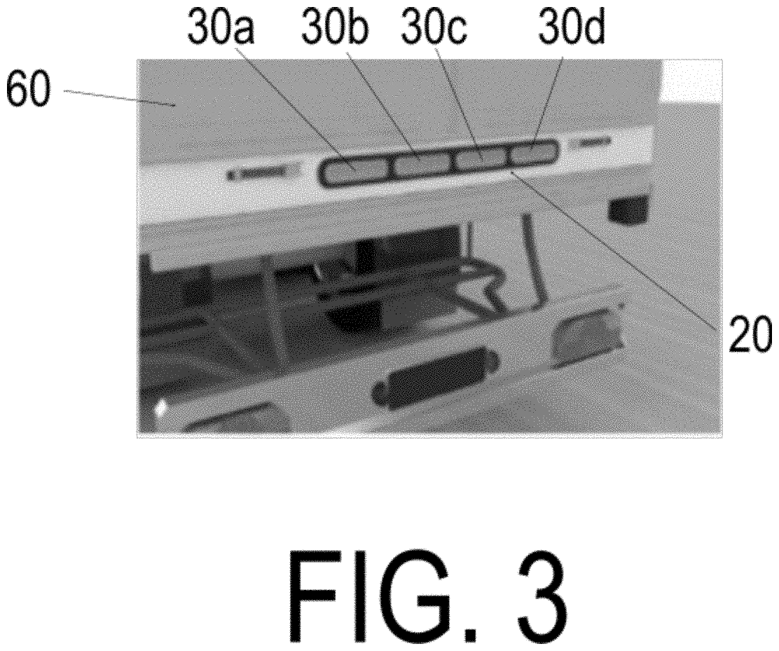

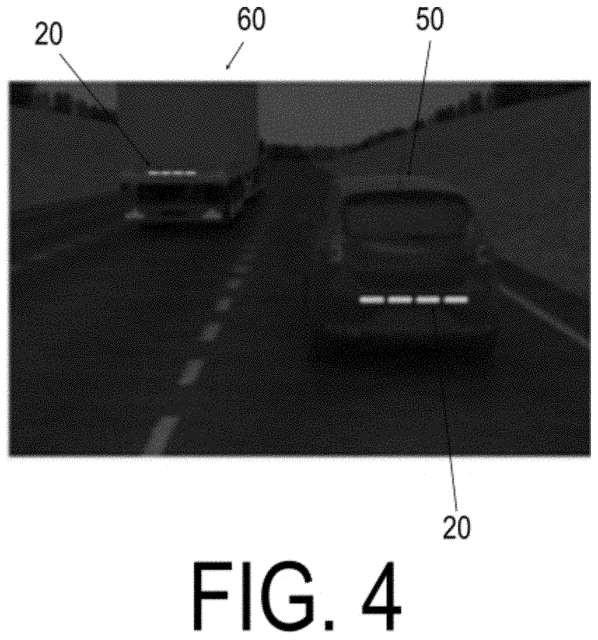

As best shown in FIG. 1, one presently preferred embodiment of the invention comprises a slow moving vehicle warning light 10 comprising a light bar 20 having a front face 22 that carries on it a plurality of LED lights 30a, 30b, 30c, 30d. As shown in FIG. 2, the rear face 24 of the light bar 20 includes a plurality of magnets 40a, 40b, 40c for removably attaching the light bar 20 to the rear of a vehicle 50 or trailer 60 as shown in FIG. 3 and FIG. 4. Although the preferred embodiment utilizes magnets to removably attach the light bar 20 to a vehicle 50 or trailer 60, other attachment means, such as tape, glue and the like are contemplated. The LED lights 30a, 30b, 30c, 30d can be powered by a battery (not shown), internal or external to the light bar 20, solar panels (not shown), or it may include wiring (not shown) connected the the vehicle 50 or trailer 60 to draw power from the vehicle or trailers's battery and/or electrical charging system. While the preferred embodiment describes LED lights, other illumination sources may be used to accomplish the goals of the invention.

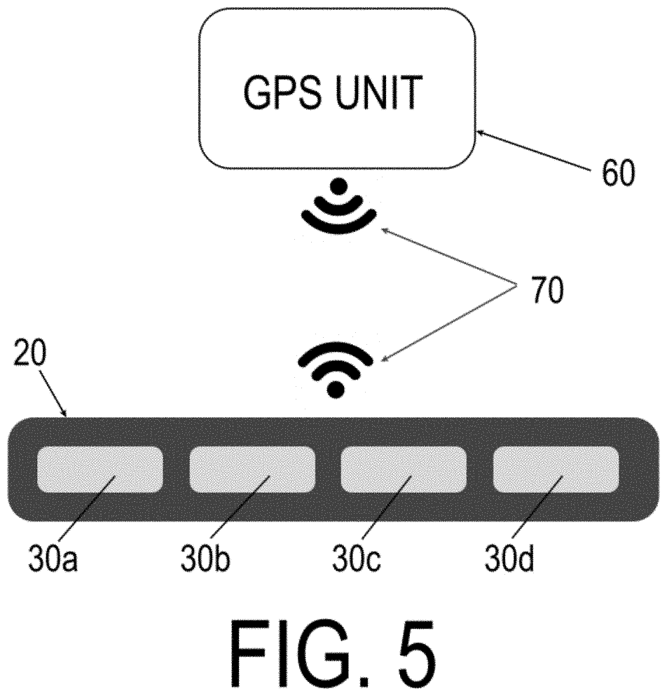

As shown in FIG. 5, a transceiver (not shown) within the light bar 20 is in communication with a transceiver (not shown) associated with a speed sensor, in this case a GPS Unit 60 via a wireless connection, such as a wi-fi connection 70. In this way, the light bar 20 activates automatically when the vehicle 50 or trailer 60 travels below a designated speed. The GPS Unit 60 is preferably located within the passenger compartment of the vehicle, but could be located anywhere, including on the light bar itself. The LED lights 30a, 30b, 30c, 30d may be configured to flash at different rates, or in different colors, such as yellow or red, depending on the speed of the vehicle.

By way of example, consider a GPS Unit 60 that is programmed with the speed limits for highways in a particular area and a sensor to determine where the vehicle is on a particular highway or roadway and the speed at which the vehicle is traveling. In order to warn other vehicles on the roadway of a potentially hazardous condition created by the vehicle traveling at speeds significantly below the posted speed limit, the GPS Unit 60 and/or light bar 20 are programmed to flash the LED lights 30a, 30b, 30c, 30d yellow when the vehicle is traveling at a speed of less than 10 miles an hour below the posted speed limit. The GPS Unit 60 and/or light bar 20 are further programmed to flash red when the vehicle is traveling at a speed of less than 20 miles an hour below the posted speed limit. In this scenario, where a vehicle is traveling on a highway with a posted speed of 60 miles per hour, the LED lights 30a, 30b, 30c, 30d will flash yellow if the vehicle is traveling at a speed of between 40 miles per hour and 50 miles per hour, and will flash red at speeds below 40 miles per hour.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

I claim:

1. A device for alerting approaching vehicles of a slow-moving vehicle comprising:
a light bar having one or more illumination units positioned on a front face thereof and a mounting mechanism on a rear face thereof for removably mounting said light bar on a vehicle;
a sensing unit for sensing the location and speed of the vehicle and for comparing the speed of the vehicle to a posted speed limit for a roadway upon which the vehicle is traveling; and
means for activating said one or more illumination units when said sensing unit determines that the speed of the vehicle is less than a pre-determined value below the posted speed limit for the roadway.

2. The device of claim 1 wherein the mounting mechanism comprises one or more magnets.

3. The device of claim 1 wherein the one or more illumination units comprises one or more LED lights.

4. The device of claim 3 wherein the one ore more LED lights are configured to flash yellow when the vehicle is less than a first pre-determined value below the posted speed limit for the roadway.

5. The device of claim 4 wherein the one ore more LED lights are configured to flash red when the vehicle is less than a second pre-determined value below the posted speed limit for the roadway.

6. The device of claim 1 wherein the sensing unit is a GPS unit.

7. The device of claim 6 wherein the light bar and GPS unit are in wireless communication with each other.

8. The device of claim 7 wherein the GPS unit is located in a passenger compartment of the vehicle.
